(19) United States
(12) Patent Application Publication
(10) Pub. No.: US 2024/0185095 A1
(43) Pub. Date: Jun. 6, 2024

(54) PREDICTION METHOD AND DEVICE USING A MACHINE LEARNING-BASED HYBRID MODEL

(71) Applicant: Impactive AI.INC, Pohang-si (KR)

(72) Inventors: Doo Hee CHUNG, Pohang-si (KR); Kang Ho LEE, Pohang-si (KR); Ye Eun BAEK, Pohang-si (KR)

(21) Appl. No.: 18/489,903

(22) Filed: Oct. 19, 2023

(30) Foreign Application Priority Data
Oct. 20, 2022 (KR) 10-2022-0135964

(51) Int. Cl. G06N 5/022; G06N 3/08

(52) U.S. Cl. CPC G06N 5/022; G06N 3/08

(57) ABSTRACT

The present disclosure retates to a method and device for prediction with a machine learning-based hybrid model. The prediction method includes: creating a first model for predicting a demand pattern for a combination of product features through K-means and ANN based on historical data; creating a second model for predicting a total demand for a period to be predicted using QRNN; predicting the demand pattern in the first model and the total demand in the second model by using features of the new product as input variables in the first model and the second model; creating a third model for calculating a specific demand for each time slot by reflecting the total demand predicted through the second model in the demand pattern calculated through the first model; and predicting a result using the third model.

### TECHNICAL FIELD

The present disclosure relates to a method and device for prediction with a machine learning-based hybrid model, and particularly, to a method and device for prediction by using a machine learning-based hybrid model that predicts a result by using an ensemble prediction model.

### BACKGROUND

New products are critical to a company's long-term success because they can rejuvenate the average age of the product portfolio and increase customer loyalty. When a new product fails in the market, the company will suffer from opportunities to compensate development costs, financial losses due to the compensation of development costs, loss of corporate image, and loss of additional investment opportunities. Therefore, in order to increase organizational performance, a company needs to have an effective new product development and launch strategy.

Especially in the retail industry, where there are a lot of trend changes, a lot of new products are released every season. In such situations, accurate demand prediction for newly launched products allows for more precise product portfolio planning and efficient supply chain planning.

Recently, various demand prediction models based on machine learning or data mining have been developed. There is proposed a model for predicting a product life cycle curve using useful covariate information including product features and promotions based on Bayesian Functional Regression, or a prediction model based on deep learning and nonlinear neural network regression. However, most studies cannot be said to have sufficiently solved the challenges of uncertainty and complexity of new products.

As a conventional technology, Korean Patent Application Publication No. 10-2020-0107087, entitled “Sales volume prediction device and method”, merely discloses a data DB storing past sales volume data for a predetet mined period of time, a data refining unit that smoothes time series data on past sales volume during the predetermined period of time by unit intervals, an index calculation unit that calculates a seasonal index according to periodic changes in the smoothed time series data, and a sales volume prediction unit that predicts future sales volume by reflecting the seasonal index on the time series data of past sales volume for the predetermined period of time, and generates sales volume prediction data including a future sales volume prediction value.

### SUMMARY

In view of the above, the present disclosure provides a method and device for predicting a sales volume of a new product using a machine learning-based hybrid model that predicts sales volume by using an ensemble prediction model that can control the uncertainty of demand for a new product to increase applicability to actual business and applying it to the case of predicting the demand for the new product.

A method of predicting a sales volume of a new product using a machine learning-based hybrid model, in accordance with the present disclosure, comprises: creating a first model for predicting a demand pattern for a combination of product features through K-means and ANN (Artificial Neural Network) based on historical data; creating a second model for predicting a total demand for a period to be predicted using QRNN (Quantile Regression Neural Network); predicting the demand pattern in the first model and the total demand in the second model by using features of the new product as input variables in the first model and the second model; creating a third model for calculating a specific demand for each time slot by reflecting the total demand predicted through the second model in the demand pattern calculated through the first model; and predicting the sales volume of the new product using the third model.

A device for predicting a sales volume of a new product using a machine learning-based hybrid model, in accordance with the present disclosure, comprises: a first model unit that creates a first model by predicting a demand pattern for a combination of product features through K-means and ANN based on historical data; a second model unit that creates a second model by predicting a total demand for a period to be predicted using QRNN; a predicting unit that predicts the demand pattern in the first model and predicts the total demand in the second model by using features of the new product as input variables in the first model and the second model; a third model unit that creates a third model by calculating a specific demand for each time slot by reflecting the total demand predicted through the second model in the demand pattern calculated through the first model; and a calculation unit that predicts the sales volume of the new product using the third model created by the third model unit.

### ADVANTAGEOUS EFFECTS

According to the present disclosure, it is possible to build a model that produces excellent results by predicting the sales patterns of a new product.

Further, according to the present disclosure, it is possible to predict the sales volume of the new product based on the built model.

### BRIEF DESCRIPTION OF THE DRAWINGS

FIG. 1 is a flowchart explaining a method of predicting demand for a new product using a machine learning-based hybrid model according to one embodiment of the present disclosure.

FIG. 2 is a flowchart illustrating a method of creating a first model based on machine learning for improving demand prediction for a new product according to one embodiment of the present disclosure.

FIG. 3 is a flowchart explaining a method of predicting a sales volume of a new product using a third model according to one embodiment of the present disclosure.

FIG. 4 is a configuration diagram of a device for predicting demand for a new product using a machine learning-based hybrid model according to one embodiment of the present disclosure.

FIG. 5 is a table showing parameters applied to each model according to one embodiment of the present disclosure.

FIG. 6 is a graph showing the sales volume pattern of each cluster according to one embodiment of the present disclosure.

FIG. 7 is a table showing prediction performance results according to one embodiment of the present disclosure.

FIG. 8 is a table showing the prediction performance of the third model according to an embodiment of the present disclosure and a benchmarking model.

### DETAILED DESCRIPTION

Specific structural or functional descriptions of embodiments according to the concept of the present disclosure disclosed in the present specification are only illustrated for the purpose of explaining the embodiments according to the concept of the present disclosure, and the embodiments according to the concept of the present disclosure may be implemented in various forms and are not limited to the embodiments described herein.

The embodiments according to the concept of the present disclosure may be variously changed and may have various forms, so the embodiments are illustrated in the drawings and described in detail in the present specification. However, this is not intended to limit the embodiments according to the concept of the present disclosure to specific disclosure forms, and the embodiments according to the concept of the present disclosure include all changes, equivalents, or substitutes included in the idea and technical scope of the present disclosure.

The terms used in the present specification are merely used to describe specific embodiments and are not intended to limit the present disclosure. Singular expressions include plural expressions unless the context clearly indicates otherwise. In the present specification, it should be understood that terms such as “comprise or include” or “have” are intended to designate the presence of features, numbers, steps, operations, components, parts, or combinations thereof described in the present specification, without excluding in advance the possibility of the presence or addition of one or more other features, numbers, steps, operations, components, parts, or combinations thereof.

Hereinafter, embodiments of the present disclosure will be described in detail with reference to the drawings attached to the present specification.

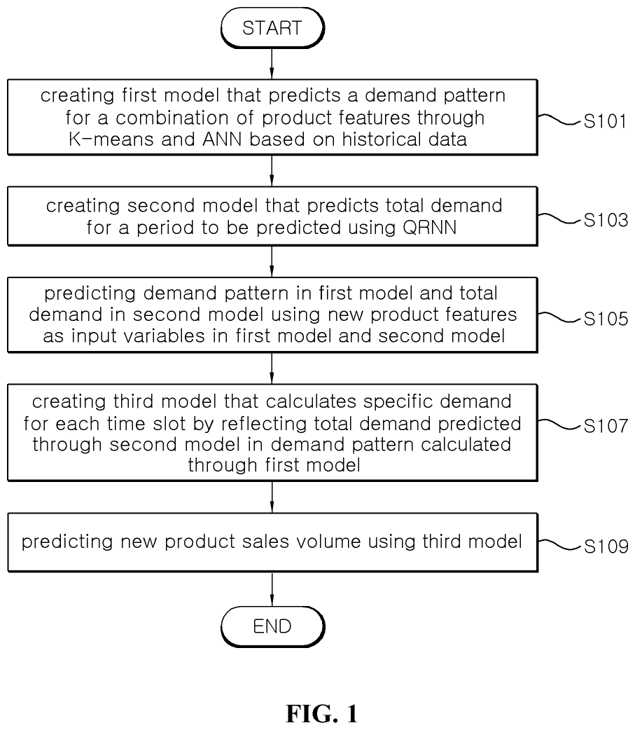

FIG. 1 is a flowchart explaining a method of predicting demand for a new product using a machine learning-based hybrid model according to one embodiment of the present disclosure.

Referring to FIG. 1, a first model that predicts a demand pattern for a combination of product features is created through K-means and ANN (Artificial Neural Network) based on historical data (S101). After clustering according to time series characteristics, ANN is used to build the first model that classifies and predicts clusters based on product features.

After creating the first model, a second model that predicts a total demand for a period to be predicted is created using QRNN (Quantile Regression Neural Network) (S103). By applying the QRNN model, it is possible to predict a total demand for a given period (the period to be predicted) based on product features. The QRNN model is a model developed based on quantile regression (QR), which can model data with non-homogeneous variance, and a neural network

(NN) approach which can capture non-linear patterns in data, and the quantile regression (QR) approach is suitable since the data used for demand prediction are generally non-uniformly distributed.

After creating the second model, the demand pattern is predicted in the first model and the total demand is predicted in the second model using features of the new product as input variables in the first model and the second model (S105). A third model that calculates a specific demand for each time slot is created by reflecting the total demand predicted through the second model in the demand pattern calculated through the first model (S107). The third model can calculate the specific demand for each time slot based on the predicted demand pattern and total demand, and the specific demand for each time slot can be calculated by combining the results of the predicted demand pattern and the total demand. In addition, the third model can calculate the specific demand by multiplying the predicted total demand by the demand proportion of each period, and the demand distribution can be confirmed by applying the upper and lower limits according to the quantile conditions provided by the QRNN model. As a result, it is possible to predict the sales volume of the new product using the third model (S109).

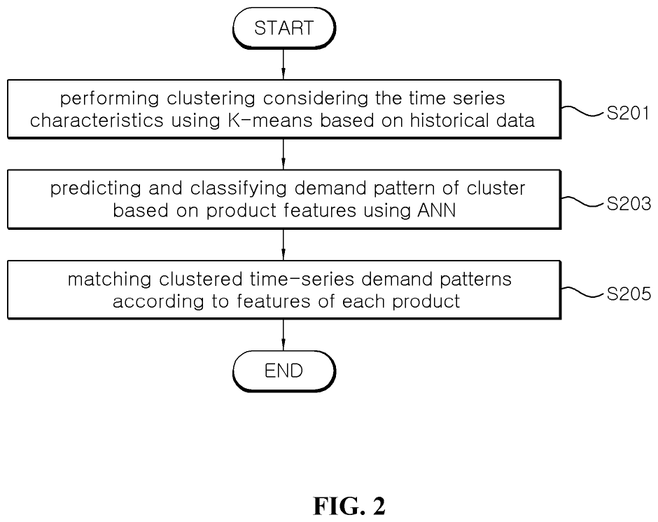

FIG. 2 is a flowchart illustrating a method of creating the first model based on machine learning for improving demand prediction for a new product according to one embodiment of the present disclosure.

Referring to FIG. 2, to create the first model, clustering considering the time series characteristics is performed using K-means based on the historical data (S201). The K-means model is the most utilized clustering model, which is a machine learning model of an unsupervised learning method that divides a given data set into a user-specified number of clusters. This model is easy to implement, computationally efficient, and low in memory consumption, and it can also quickly and efficiently cluster large amounts of data, including outliers, so that when the prediction model is trained for each cluster separately after applying clustering through the K-means model, each cluster is grouped with data with similar data patterns, which can further improve the accuracy of the prediction.

After the clustering is performed, the demand pattern of the cluster is predicted and classified based on the features of the product using ANN (S203). Based on each cluster clustered by the K-means model, the ANN model can predict and classify the demand pattern of the cluster based on the features of the product using an ANN algorithm. The ANN algorithm is a learning algorithm inspired by the biological nervous system of the human brain, and a single hidden-layer feedforward network is one of the most frequently used methods in the prediction field. After the classification of the demand patterns of each cluster is completed, the clustered time-series demand patterns are matched according to the features of each product (S205).

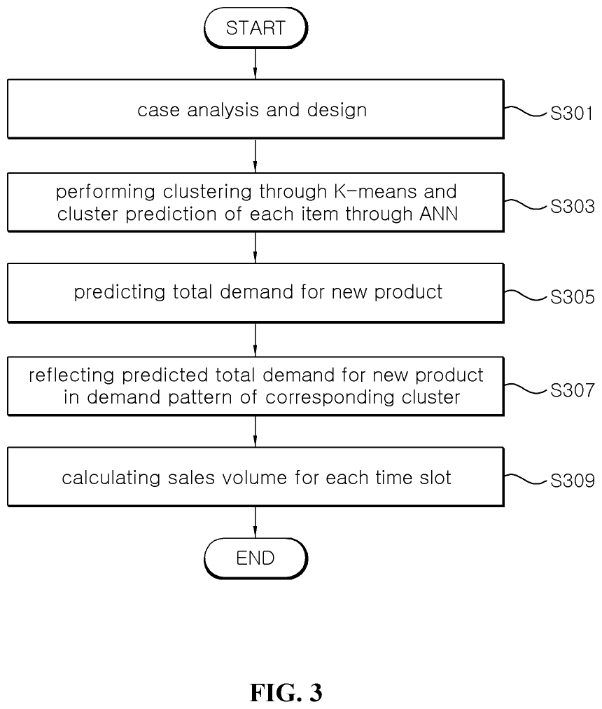

FIG. 3 is a flowchart explaining a method of predicting a sales volume of a new product using the third model according to one embodiment of the present disclosure.

Referring to FIG. 3, a case is analyzed and designed to apply the third model that calculates the specific demand for each time slot (S301). Then, clustering through K-means and cluster prediction of each item through ANN in the third model are performed (S303). In addition, the total demand for the new product is predicted through QRNN using the item features as input values (S305) and reflected in the demand pattern of the corresponding cluster (S307), and the detailed sales volume for each time slot is calculated (S309). Prediction of the sales volume of the new product will be described in more detail later with reference to an example of the embodiment of the present disclosure.

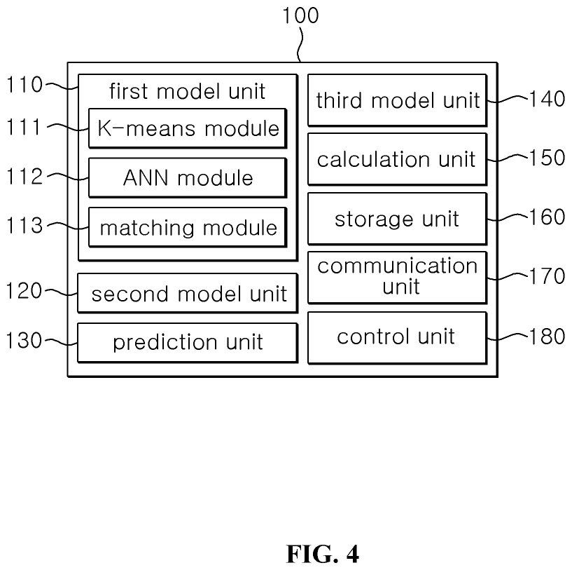

FIG. 4 is a configuration diagram of a device for predicting demand for a new product using the machine learning-based hybrid model according to one embodiment of the present disclosure.

Referring to FIG. 4, a new product demand prediction device 100 using the machine learning-based hybrid model includes a first model unit 110, a second model unit 120, a prediction unit 130, a third model unit 140, a calculation unit 150, a storage unit 160, a communication unit 170, and a control unit 180.

The first model unit 110 includes a K-means module 111, an ANN module 112, and a matching module 113. The K-means module 111 may perform clustering considering time series characteristics using a K-means model based on historical data. The K-means model is the most utilized clustering model, which is a machine learning model of an unsupervised learning method that divides a given data set into a user-specified number of clusters. This model is easy to implement, computationally efficient, and low in memory consumption, and it can also quickly and efficiently cluster large amounts of data, including outliers, so that when the prediction model is trained for each cluster separately after applying clustering through the K-means model, each cluster is grouped with data with similar data patterns, which can further improve the accuracy of the prediction.

In order to divide the data into highly similar groups through the K-means model, the K-means module 111 may determine a K-value, which is the number of clusters. In this case, an optimal K-value may be determined using at least one of the Davies-Bouldin index, the silhouette coefficient, the CalinskiHarabasz index, and majority voting to find the optimal K-value without being limited to the above. After determining the K-value which is the number of clusters, the K-means module 111 may start by selecting a center seed of the initial cluster. The method of selecting the center seed of the initial cluster may be at least one of using K random observations from the data set, clustering a small subset of the data, or perturbing the global mean of the data K times without being limited to the above. The K-means module 111 may partition the data into K clusters by assigning them to the closest center among the center seeds of the set initial cluster. The K-means module 111 may measure the distance between each data and the center seed by applying the Euclidean distance formula, and then measure an average distance between the data assigned to each cluster. In one embodiment, if each data point is called xi, and the center of each cluster is called yi, then the distance of each data from the center seed can be calculated as Eq. 1.

dist(x, y)=\sqrt{Σᵢ₌₁ⁿxᵢ−yᵢ²} (Eq. 1)

The K-means module 111 may relocate the center seed of the initial cluster to the average position among the data assigned to each cluster, and group the data with a minimum distance according to the center seed of the relocated cluster. The K-means module 111 may continue to repeat the above process until no further cluster changes occur. The K-means module 111 may perform the above repetition a finite number of times. Each cluster clustered by the K-means module 111 has a unique demand pattern, and Table 1 shows an overview of time series characteristics.

TABLE 1

| Feature | Description |
|---|---|
| Trend | Strength of trend |
| Spikiness | Strength of spikiness |
| Linearity | Strength of linearity |
| Curvature | Strength of curvature |
| ACF1-e | Autocorrelation coefficient at lag 1 of the residuals |
| ACF1-x | Autocorrelation coefficient at lag 1 |
| Entropy | Spectral entropy |

Based on each cluster clustered by the K-means module 111, the ANN module 112 can predict and classify the demand patterns of the clusters based on the features of the product using the ANN algorithm. The ANN algorithm is a learning algorithm inspired by the biological nervous system of the human brain, and the single hidden-layer feedforward network is one of the most frequently used methods in the field of prediction. The ANN includes highly interconnected processing elements called neurons, which include weights, biases, and activate functions. For each input, each neuron multiplies weight Xᵢ, which represents the strength of the connection for each connection, and sums bi. In other words, the ANN has the nature of a connection weight in which the given input and corresponding weight are reflected and a constant value other than 0 is added, and the basic formula of the ANN is as in the following Eq. 2.

uᵢΣⱼ₌ᵢⁿWᵢⱼXⱼ+bᵢ (Eq. 2)

In Eq. 2, uᵢ represents the internal activity level of the i-th neuron, Wᵢⱼ represents the j-th weight of the i-th layer, Xⱼ represents the output value of the j-th layer, and n represents the number of neurons. The ANN module 112 can generate the output value by applying an activate function that converts the weighted sum of the data input in Eq. 2 into an output signal. The activate function may be at least one of a sigmoid function, a hyperbolic tangent function (Tanh), a softmax function, and a rectified linear unit function (Relu function) without being limited thereto. The ANN module 112 may update the parameters such that the loss function is minimized. In this case, the ANN module 112 may use a gradient descent method, which may be specifically at least one of a Stochastic Gradient Descent method, a Momentum method, an AdaGrad method, and an Adadelta method without being limited thereto.

The matching module 123 may create a first model that matches the clustered time-series demand patterns according to the features of each product, based on the ANN module 112′s classification and prediction of the clusters based on the product features.

By applying the QRNN model, the second model unit 120 can create a second model that predicts a total demand for a given time period (the time period to be predicted) based on the product features. The QRNN is a model developed based on quantile regression (QR), which can model data with non-homogeneous variance, and the neural network (NN) approach which can capture non-linear patterns in the data, and the quantile regression QR approach is suitable because the data used for demand prediction is generally non-uniformly distributed. The QRNN model is based on a single hidden layer feed-forward network that can simulate nonlinear structures. This reveals the effect of independent variables on the overall conditional distribution of the dependent variable, and the formulas applied to the QRNN are as the following Eqs. 3 and 4.

Q_{yi}(φ|xᵢ)=f(xᵢ, Mᵢ(φ), Uᵢ(φ)), i=1,2,3 . . . , n (Eq. 3)

f(xᵢ, Mᵢ(φ), Uᵢ(φ))=g₂[Σₖ₌₁^{K} u_{i,k}(φ)g₁{Σₜ₌₁^{J}t_{ij,k}(φ)xᵢ}] (Eq. 4)

f(xᵢ, Mᵢ(φ), Uᵢ(φ)) is the nonlinear function applied by summing the weight vectors. More specifically, φ is each quantile. Mᵢ is the estimated weight matrix between the input and hidden layers. Uᵢ represents the connection weight vector between the hidden and output layers. gᵢ is the activation function of the hidden layer using hyperbolic tangent sigmoid, and g2 is the function of the output layer represented by a general linear model. The error function applied to the QRNN model is as the following Eq. 5.

O(M(φ),U(φ))=min Σᵢ₌ₐⁿτ_{φ}[(yᵢ(φ)−f(xᵢMᵢ(φ))]+v₁Σ_{ij,k}m²_{ij,k}+v₂Σ_{i,k}v₂Σ_{i,k}u²_{i,k} (Eq. 5)

The second model unit 120 may obtain parameter estimate values of M(φ)=(M₁, M₂, M₃, . . . , Mₙ), U(φ)=M(φ)=(U₁, U₂, U₃, . . . , Uₙ) through Eq. 5. v₁ and v₂ are model penalty parameters that prevent the model from overfitting. The optimal estimate values of M(φ) and U(φ) may be derived through optimization of this formula. τ_{φ} is the loss function as the following Eq. 6.

$${τ}_{φ} ( u ) = \{ \begin{matrix}φ u , u \geq 0 \\ ( φ - 1 ) u , u < 0\end{matrix} \qquad ( Eq . 6 )$$

After obtaining the optimal estimate values of M(φ) and U(φ), the conditional quantile of the response variable Q_{Y}(φ|X) can be formulated as the following Eq. 7.

[symbol]

(φ|X)=f (X, [symbol] (φ), Û(φ)) (Eq. 7)

In this case, \hat{M}(φ) and Û(φ) mean the estimate values of M(φ) and U(φ). respectively.

The prediction unit 130 may predict the demand pattern using new product data features as input variables of the first model created by the first model unit 110. Further, the prediction unit 130 may predict the total demand using new product data features as input variables of the second model created by the second model unit 120.

The third model unit 140 may create the third model that calculates a specific demand for each time slot by reflecting the total demand predicted by the prediction unit 130 through the first model unit 110 in the demand pattern predicted by the prediction unit 130 through the second model unit 120. The third model unit 140 may calculate the specific demand for each time slot by creating the third model based on the demand pattern and the total demand predicted by the prediction unit 130, and the specific demand for each time slot may be calculated by combining the results of the predicted demand pattern and total demand. The third model unit 140 may calculate the specific demand by multiplying the total demand predicted by the prediction unit 130 by a demand proportion for each period, and may confirm the demand distribution together by applying the upper and lower limits depending on the quantile conditions provided by the QRNN of the second model unit 120.

In the present specification, neural network and network function may be used interchangeably. The neural network may include a set of interconnected computational units, which can be generally referred to as nodes. These nodes may also be referred to as neurons. The neural network includes at least one node. The nodes (or neurons) that make up the neural network may be interconnected by one or more links. Within the neural network, one or more nodes connected through the links may relatively form an input node and output node relationship. The concepts of input node and output node are relative, and any node in the output node relationship with one node may be in the input node relationship with another node, and vice versa. As described above, the relationship of input node to output node may be created around the links. One or more output nodes may be connected to one input node through the links, and vice versa.

In the relationship between the input node and the output node connected through one link, the value of data of the output node may be determined based on data input to the input node. In this case, the link connecting the input node and the output node may have a weight. The weight may be variable and may be varied by a user or algorithm in order for the neural network to perform the desired function. For example, when one or more input nodes are connected to one output node by respective links, the output node may determine the output node value based on the values input to the input nodes connected to the output node and the weights set for the links corresponding to the respective input nodes.

As described above, in the neural network, one or more nodes are interconnected through one or more links to form the input node and output node relationship within the neural network. The characteristics of the neural network may be determined according to the number of nodes and links, the correlation between the nodes and the links, and the value of the weight assigned to each link within the neural network. For example, when there are two neural networks with the same number of nodes and links and different weight values of the links, the two neural networks may be recognized as different from each other.

The neural network may include a set of one or more nodes. A subset of nodes that constitutes the neural network may form a layer. Some of the nodes constituting the neural network may form one layer based on the distances from the initial input node. For example, a set of nodes with a distance n from the initial input node may constitute an n layer. The distance from the initial input node may be defined by the minimum number of links that should be passed to reach the node from the initial input node. However, this definition of the layer is arbitrary for explanation purposes, and the order of the layer within the neural network may be defined in a different way than described above. For example, a layer of nodes may be defined by the distance from the final output node.

The initial input node may refer to one or more nodes in the neural network through which data is directly input without going through any link in relationships with other nodes. Alternatively, in the neural network, in the relationship between nodes based on links, the initial input node may mean nodes that do not have other input nodes connected by links. Similarly, the final output node may refer to one or more nodes that do not have an output node in relationship with other nodes among the nodes in the neural network. In addition, hidden nodes may refer to nodes constituting the neural network other than the initial input node and the final output node.

The neural network according to one embodiment of the present disclosure may be a neural network in which the number of nodes in the input layer may be the same as the number of nodes in the output layer, and the number of nodes decreases and then increases as it progresses from the input layer to the hidden layer. In addition, the neural network according to another embodiment of the present disclosure may be a neural network in which the number of nodes in the input layer may be less than the number of nodes in the output layer, and the number of nodes decreases as it progresses from the input layer to the hidden layer. Further, the neural network according to still another embodiment of the present disclosure may be a neural network in which the number of nodes in the input layer may be greater than the number of nodes in the output layer, and the number of nodes increases as it progresses from the input layer to the hidden layer. The neural network according to still another embodiment of the present disclosure may be a neural network that is a combination of the above-described neural networks.

A deep neural network (DNN) may refer to a neural network that includes multiple hidden layers in addition to the input layer and output layer. The deep neural network can be used to identify latent structures in data. In other words, it is possible to identify the latent structure of a photo, text, video, voice, or music (e.g., what object is in the photo, what the content and emotion of the text are, what the content and emotion of the voice are, etc.). The deep neural network may include a convolutional neural network (CNN), a recurrent neural network (RNN), an autoencoder, a generative adversarial network (GAN), and a restricted Boltzmann machine (RBM), a deep belief network (DBN), a Q network, a U network, a Siamese network, a generative adversarial Network (GAN), etc. The description of the deep neural network described above is only an example and the present disclosure is not limited thereto.

In one embodiment of the present disclosure, the network function may include an autoencoder. The autoencoder may be a type of artificial neural network to output output data similar to input data. The autoencoder may include at least one hidden layer, and an odd number of hidden layers may be placed between the input and output layers. The number of nodes in each layer may be reduced from the number of nodes in the input layer to an intermediate layer called a bottleneck layer (encoding), and then expanded symmetrically from the bottleneck layer to the output layer (symmetrical to the input layer). The autoencoder may perform nonlinear dimensionality reduction. The number of input layers and output layers may correspond to the dimensionality after preprocessing of the input data. The autoencoder may have a structure in which the number of nodes in the hidden layer included in the encoder decreases as the distance from the input layer increases. If the number of nodes in the bottleneck layer (the layer with the fewest nodes located between the encoder and decoder) is too small, a sufficient amount of information may not be conveyed, so the number of nodes in the bottleneck layer may be kept above a certain number (e.g., more than half of the input layers, etc.).

The neural network may be trained by at least one of supervised learning, unsupervised learning, semi-supervised learning, or reinforcement learning. Learning of the neural network may be a process of applying knowledge for the neural network to perform a specific operation to the neural network.

The neural network may be trained to minimize output errors. The neural network training is a process of repeatedly inputting learning data into the neural network, calculating the output of the neural network and the error of the target for the learning data, and updating the weight of each node in the neural network by backpropagating the error of the neural network is transferred from the output layer of the neural network to the input layer in the direction of reducing the error. In the case of supervised learning, learning data in which the correct answer is labeled in each learning data is used (i.e., labeled learning data), and in the case of unsupervised learning, no correct answer may be labeled in each learning data. That is, for example, in the case of supervised learning for data classification, the learning data may be data in which each learning data is labeled with a category. The labeled learning data is input to the neural network, and the error can be calculated by comparing the output (category) of the neural network with the label of the learning data. As another example, in the case of unsupervised learning for data classification, the error can be calculated by comparing the input learning data with the neural network output. The calculated error is backpropagated in the reverse direction (i.e., from the output layer to the input layer) in the neural network, and the connection weight of each node of each layer in the neural network can be updated according to backpropagation. The amount of change in the connection weight of each node updated may be determined according to a learning rate. The calculation of the neural network on the input data and backpropagation of errors can constitute a learning cycle (epoch). The learning rate may be applied differently depending on the number of repetitions of the learning cycle of the neural network. For example, in the early stages of the neural network training, a high learning rate may be used to increase efficiency by allowing the neural network to quickly achieve a certain level of performance, and in the later stages of the training, a low learning rate may be used to increase accuracy.

In the training of the neural network, the learning data may generally be a subset of actual data (i.e., the data to be processed using the trained neural network), so there may be a learning cycle where the error on the learning data decreases but the error on the actual data increases. Overfitting is a phenomenon in which errors in actual data increase due to excessive learning on learning data. For example, a phenomenon in which a neural network that has learned to recognize a cat by showing it a yellow cat fails to recognize a cat when it sees a non-yellow cat, which is a type of overfitting.

The overfitting may lead to increased errors in machine learning algorithms. Various optimization methods may be used to prevent such overfitting. To prevent overfitting, methods such as increasing the learning data, regularization, dropout to disable some of the network nodes during the training process, and use of a batch normalization layer may be applied.

The calculation unit 150 may calculate and predict the sales volume of the new product using the third model created by the third model unit 140. In addition, the calculation unit 150 may calculate and evaluate the prediction performance of the third model. As a main performance criteria used in the evaluation of a prediction model such as the third model of the present disclosure, at least one of MAE (mean absolute error), RMSLE (root mean square log error), and sMAPE (symmetric mean absolute percentage error) may be used, but the present disclosure is not limited to the above. The equation for the MAE is as the following Eq. 8.

$$MAE = \frac{1}{N} {\sum }_{i = 1}^{N} \vert {\hat{y}}_{i} - {y}_{i} \vert \qquad ( Eq . 8 )$$

The equation for the RMSLE is as the following Eq. 9.

$$RMSLE = \sqrt{\frac{1}{N} {\sum }_{i = 1}^{N} {( log ( {p}_{i} + 1 ) - log ( {α}_{i} + 1 ) )}^{2}} \qquad ( Eq . 9 )$$

The equation for the sMAPE is as the following Eq. 10.

$$sMAPE = \frac{100}{N} {\sum }_{i = 1}^{N} \frac{\vert {\hat{y}}_{i} - {y}_{i} \vert}{( ( \vert {\hat{y}}_{i} \vert + \vert {y}_{i} \vert / 2} \qquad ( Eq . 10 )$$

In this case, yᵢ is the actual correct answer value and ŷᵢ is the predicted value, and the smaller the values of each MAE, RMSLE, and sMAPE, the better the prediction performance.

The storage unit 160 stores each component value of the process related to building a machine learning-based hybrid model for advanced new product demand prediction.

The communication unit 170 allows the machine learning-based hybrid model building device 100 for advanced new product demand prediction to communicate, through a network, with the service providing server, and other user terminals, and receives information for studying a highly complete prediction model that reflects data through product users' satisfaction with each function by utilizing historical data for model creation and new product features as weights. The network includes a local area network (LAN), a wide area network (WAN), a value added network (VAN), a mobile radio communication network, a satellite communication network, and combinations thereof. It is a data communication network in a comprehensive sense and may include wired Internet, wireless Internet, and mobile wireless communication networks. In addition, the wireless communications may include, for example, but are not limited to, wireless LAN (Wi-Fi), Bluetooth, Bluetooth low energy, ZigBee, WFD (Wi-Fi Direct), UWB (ultra wideband), and IrDA (Infrared Data Association), NFC (Near Field Communication), etc.

The control unit 180 controls the processing of processes related to building a machine learning-based hybrid model for advanced new product demand prediction, and controls the operation of each component.

Hereinafter, an example applied to the retail industry in Korea to verify the method and device for predicting the sales volume of the new product using the machine learning-based hybrid model of the present disclosure will be described. The data set in this example contains weekly sales volume information of new products by item from Jan. 1, 2018 to Apr. 30, 2022, and includes 20852 valid samples for a total of 12 weeks. Each item has an identified launch date, the analysis includes sales data from the first quarter (12 weeks) after launch, and there are a total 15 of 20852 items.

Further, the input variables used to predict the weekly sales volume for each item, which is the response variable in this example, are additionally created features based on the features and sales volume of each item. Learning and validation data are data from 2018 to 2020, and test data are data from January to April 2022, and categories were classified into target variable, transaction attribute and product feature. In the target variable category, sales volume and total sales volume per quarter were used as variables, and in the transaction attribute category, sales year, sale month, sale date, sales date total, season, cost, sale price, sales, discount rate, and transaction ID were used as variables. Further, in the product feature category, product name, detailed code, product major category, product middle category, product description, brand name, product minor category, gender category (M, F, U), product detailed category, design category 1, design category 2, color, size, store type, store name, post-launch period (week), and launch month were used as variables.

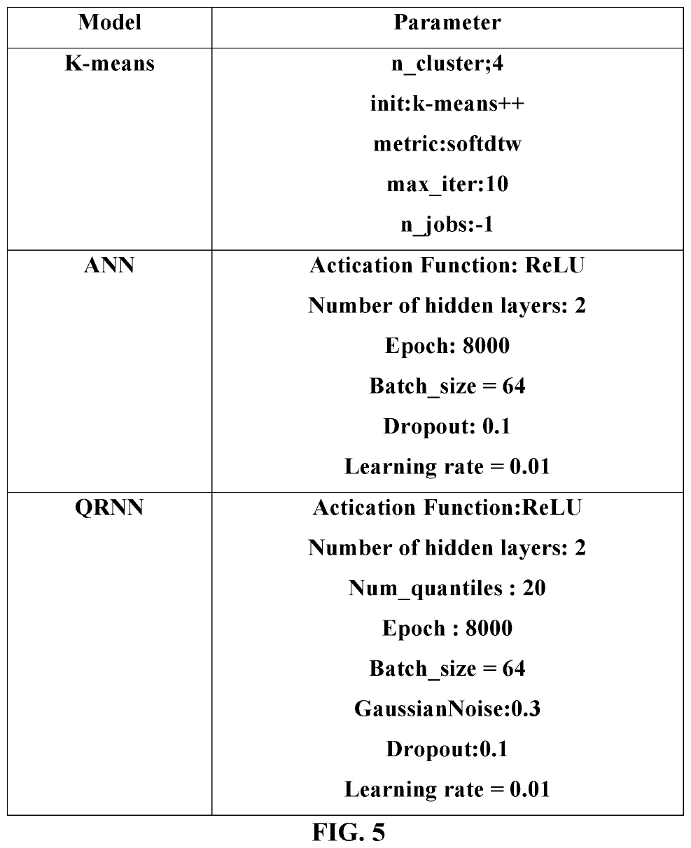

First, clustering through K-means and cluster prediction of each item through ANN are performed. Then, the item features are used as input values, the total demand for 12 weeks is predicted through QRNN, and the specific demand for each week is calculated by reflecting it in the demand pattern of the cluster. FIG. 5 shows the parameters applied to each model (K-means, ANN, and QRNN).

To evaluate the performance of the third model used in this example, the benchmarking model is set as follows. As a method commonly used in existing prediction models, the benchmarking model uses product features as input variables and uses a single algorithm to predict weekly sales. This includes random forests and ANN. The second method is the same as the first method, but applies QRNN as a single model. Through comparison with this model, the combination effect of clustering and cluster prediction model using K-means and ANN can be confirmed. The third benchmarking method is used in the field of demand prediction. Instead of clustering, the method is to inherit the demand pattern of each item's parent category and combine it with the total demand of QRNN. The fourth is the K-means+ANN+ANN model.

ANN was applied as a model to predict the total demand for each item for 12 weeks. Through this, it is possible to confirm the total demand prediction effect of QRNN.

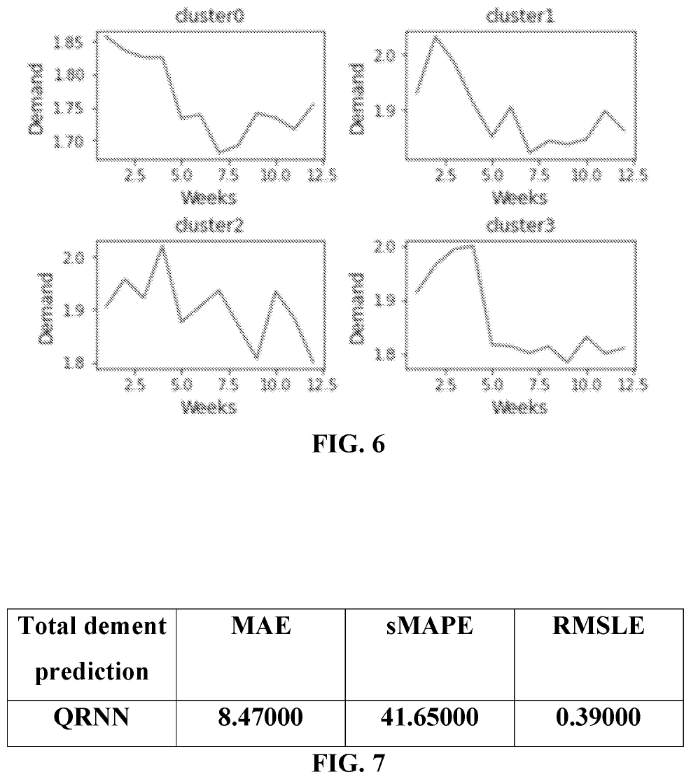

The first step is clustering using K-means. In order to derive the optimal number of clusters, the silhouette coefficient, the Davies-Bouldin index, and the majority vote of the Calinski- Harabasz index were checked, and the optimal number of clusters K was found to be 4. Therefore, in this example, the analysis was conducted by setting four clusters to distinguish the new product sales volume pattern over a 12-week period. FIG. 6 shows the sales volume pattern of each cluster.

Next, it is needed to classify which cluster, or demand pattern, the new product falls into. For this purpose, classification prediction is made using the features of each new product as a predictor variable and the cluster as an outcome variable. By applying ANN, the accuracy of cluster classification for sales volume pattern was found to be 0.733, which is acceptable.

Then, the total demand for the new product during a period to be predicted is predicted. The predictions are made using QRNN with the features of the new product as the predictor variable and the total demand for 12 weeks as the outcome variable. The results of the prediction performance are shown in FIG. 7.

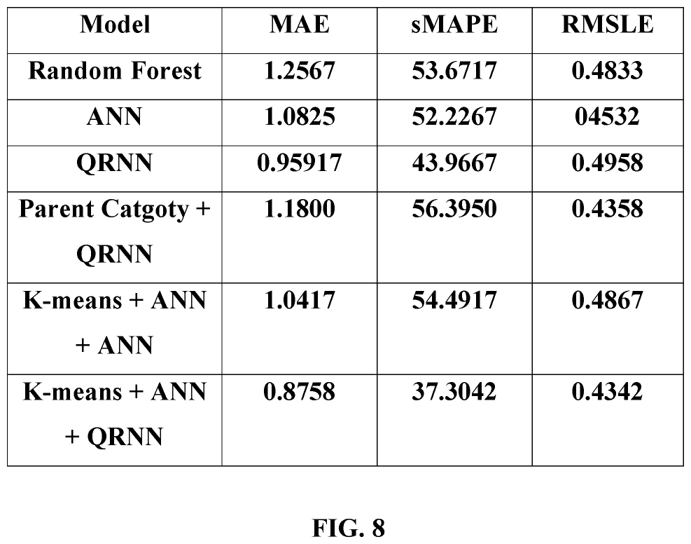

Finally, the total demand predicted through QRNN is multiplied by the weekly sales volume proportion of each cluster to calculate the specific sales volume for each week. The graph showing the actual and predicted values for sales volume for each week is as follows. The prediction performance of the model proposed in this study and the benchmarking model are shown in FIG. 8.

The prediction results show that the third model of the present disclosure is the best for all three evaluation indicators compared to other benchmarking models. Compared to single machine learning which is generally applied to product demand prediction, the model combining clustering and total demand through K-means was found to be generally superior. This was superior to the model predicted by applying the demand pattern of the parent category. As a model for predicting total sales volume, QRNN is superior to ANN, confirming that the quantile regression approach is superior to general prediction models. These results prove the validity of the direction proposed in this model for predicting demand for the new product.

The present disclosure has been described with reference to the embodiments shown in the drawings, but these are merely exemplary, and those skilled in the art will understand that various modifications and other equivalent embodiments are possible therefrom. Accordingly, the true technical protection scope of the present disclosure should be defined by the technical idea of the attached claims.

(Description of Reference Numerals)

| | |
|---|---|
| 100: new product demand prediction device | |
| using machine learning-based hybrid model | |
| 110: first model unit | 111: K-means module |
| 112: ANN module | 113: matching module |
| 120: second model unit | 130: prediction unit |
| 140: third model unit | 150: calculation unit |
| 160: storage unit | 170: communication unit |
| 180: control unit | |

What is claimed is:

1. A method of predicting a sales volume of a new product using a machine learning-based hybrid model, the method comprising:
creating a first model for predicting a demand pattern for a combination of product features through K-means and ANN (Artificial Neural Network) based on historical data;
creating a second model for predicting a total demand for a period to be predicted using QRNN (Quantile Regression Neural Network);
predicting the demand pattern in the first model and the total demand in the second model by using features of the new product as input variables in the first model and the second model;
creating a third model for calculating a specific demand for each time slot by reflecting the total demand predicted through the second model in the demand pattern calculated through the first model; and
predicting the sales volume of the new product using the third model.

2. The method of claim 1, wherein the predicting of the sales volume of the new product using the third model includes:
analyzing and designing a case;
performing clustering through K-means and cluster prediction of each item through ANN;
predicting a total demand for a new product;
reflecting the total demand for the predicted new product in a demand pattern of the corresponding cluster; and
calculating sales volume for each time slot.

3. The method of claim 1, wherein the creating of the first model includes:
performing clustering considering time series characteristics using K-means based on historical data; and
predicting and classifying the demand pattern of the cluster based on product features using ANN.

4. The method of claim 3, further comprising:
matching time series demand patterns clustered according to feature of each product.

5. A device for predicting a sales volume of a new product using a machine learning-based hybrid model, the device comprising:
a first model unit that creates a first model by predicting a demand pattern for a combination of product features through K-means and ANN based on historical data;
a second model unit that creates a second model by predicting a total demand for a period to be predicted using QRNN;
a predicting unit that predicts the demand pattern in the first model and predicts the total demand in the second model by using features of the new product as input variables in the first model and the second model;
a third model unit that creates a third model by calculating a specific demand for each time slot by reflecting the total demand predicted through the second model in the demand pattern calculated through the first model; and
a calculation unit that predicts the sales volume of the new product using the third model created by the third model unit.
